(19) United States
(12) Patent Application Publication
(10) Pub. No.: US 2019/0014410 A1
(43) Pub. Date: Jan. 10, 2019

(54) NOTIFYING OF A MISMATCH BETWEEN AN AUDIO JACK AND AN AUDIO SOCKET

(71) Applicant: QUALCOMM Incorporated, San Diego, CA (US)

(72) Inventors: Parthasarathy KRISHNAMOORTHY, San Diego, CA (US); Raevanth Venkat ANNAM, Hyderabad (IN); Prashanth MOHAN, Chennai (IN); Naveen Kumar PASUNOORU, Hyderabad (IN)

(21) Appl. No.: 15/644,736

(22) Filed: Jul. 7, 2017

(51) Int. Cl. H04R 3/00; H04R 29/00; H01R 24/58

(52) U.S. Cl. CPC H04R 3/007; H01R 24/58; H04R 29/00

(57) ABSTRACT

Disclosed are techniques for detecting a mismatch between a type of an audio socket of an electronic device and a type of an audio jack. In an aspect, an electronic device detects that the audio jack is plugged into the audio socket, accesses application layer log data related to the audio socket, determines that the type of the audio socket does not match the type of the audio jack based on the application layer log data, and in response to determining that the type of the audio socket does not match the type of the audio jack, displays a notification of the mismatch on a user interface of the electronic device.

### BACKGROUND

### 1. Field of the Disclosure

Aspects of the disclosure relate to notifying of a mismatch between an audio jack and an audio socket.

### 2. Description of the Related Art

Many electronic devices are equipped with audio sockets capable of receiving an audio jack. Audio jacks and audio sockets typically have two, three, four, or sometimes five contacts. Three-contact audio jacks/sockets are referred to as TRS audio jacks/sockets, where T stands for “tip,” R stands for “ring,” and S stands for “sleeve.” Similarly, two-, four-, and five-contact audio jacks/sockets are referred to as TS, TRRS, and TRRRS audio jacks/sockets, respectively.

Generally, the type of audio jack should match the type of audio socket. For example, if an audio jack is plugged into a TRRS audio socket, the audio jack should be a TRRS audio jack. However, since audio jacks and audio sockets are available in different contact configurations (e.g., TS, TRS, TRRS, etc.), it is possible to have a mismatch between an audio jack and an audio socket. While some mismatches between the type of audio jack and the type of audio socket do not have any deleterious effects on the electronic device, such as a TRS audio jack in a TRRS audio socket, other combinations may cause damage to the audio hardware of the electronic device. Additionally, some mismatches, such as a TRRS audio jack in a TRS audio socket, may alter the functionality of the electronic device, such as muting the microphone of the electronic device. A mismatch can also occur even when both the audio jack and the audio socket have the same contact configuration. For example, some manufacturers of TRRS audio jacks and audio sockets switch the positions of the specific ground and microphone contacts.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of detecting a mismatch between a type of an audio socket of an electronic device and a type of an audio jack includes detecting, by the electronic device, that the audio jack is plugged into the audio socket, accessing, by the electronic device, application layer log data related to the audio socket, determining, by the electronic device, that the type of the audio socket does not match the type of the audio jack based on the application layer log data, and in response to determining that the type of the audio socket does not match the type of the audio jack, displaying, by the electronic device, a notification of the mismatch on a user interface of the electronic device.

In an aspect, an apparatus for detecting a mismatch between a type of an audio socket of an electronic device and a type of an audio jack includes the audio socket, a memory configured to store application layer log data related to the audio socket, and at least one processor configured to: detect that the audio jack is plugged into the audio socket, access the application layer log data related to the audio socket from the memory, and determine that the type of the audio socket does not match the type of the audio jack based on the application layer log data, and a user interface configured to display, in response to the determination that the type of the audio socket does not match the type of the audio jack, a notification of the mismatch.

In an aspect, an apparatus for detecting a mismatch between a type of an audio socket of an electronic device and a type of an audio jack includes the audio socket, a storage means configured to store application layer log data related to the audio socket, and a processing means configured to: detect that the audio jack is plugged into the audio socket, access the application layer log data related to the audio socket from the storage means, and determine that the type of the audio socket does not match the type of the audio jack based on the application layer log data, and an interface means configured to display, in response to the determination that the type of the audio socket does not match the type of the audio jack, a notification of the mismatch.

In an aspect, a non-transitory computer-readable medium storing computer-executable instructions for detecting a mismatch between a type of an audio socket of an electronic device and a type of an audio jack includes computer-executable instructions comprising at least one instruction to cause the electronic device to detect that the audio jack is plugged into the audio socket, at least one instruction to cause the electronic device to access application layer log data related to the audio socket, at least one instruction to cause the electronic device to determine that the type of the audio socket does not match the type of the audio jack based on the application layer log data, and at least one instruction to cause the electronic device to display, in response to determining that the type of the audio socket does not match the type of the audio jack, a notification of the mismatch on a user interface of the electronic device.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure will be readily obtained as the same becomes better understood by reference to the following detailed description when considered in connection with the accompanying drawings which are presented solely for illustration and not limitation of the disclosure, and in which:

FIG. 1 illustrates the tip (T), ring (R), and sleeve (S) configuration of various types of audio jacks.

FIG. 2 illustrates an exemplary method for detecting a mismatch between a type of an audio socket of an electronic device and a type of an audio jack.

FIG. 3 illustrates an example of an electronic device in accordance with aspects of the disclosure.

FIG. 4 is a simplified block diagram of several sample aspects of an apparatus configured to support operations as taught herein.

### DETAILED DESCRIPTION

Disclosed are techniques for detecting a mismatch between a type of an audio socket of an electronic device and a type of an audio jack. In an aspect, an electronic device detects that the audio jack is plugged into the audio socket, accesses application layer log data related to the audio socket, determines that the type of the audio socket does not match the type of the audio jack based on the application layer log data, and in response to determining that the type of the audio socket does not match the type of the audio jack, displays a notification of the mismatch on a user interface of the electronic device.

These and other aspects of the disclosure are disclosed in the following description and related drawings directed to specific aspects of the disclosure. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As noted above, many electronic devices are equipped with audio sockets capable of receiving an audio jack. An audio jack is also known as, among other things, a phone connector, a phone jack, a headphone jack, or a jack plug. Audio jacks are manufactured in various sizes, most commonly, 6.35 mm, 3.5 mm, and 2.5 mm A 3.5 mm audio jack is referred to as a “mini” audio jack, and a 2.5 mm audio jack is referred to as a “sub-mini” audio jack.

Numerous types of electronic devices utilize audio jacks and audio sockets. For example, audio jacks serve as headphone and earphone jacks on a wide range of equipment. 6.35 mm audio jacks are common on home and professional component equipment, while 3.5 mm audio jacks are common for portable equipment, such as portable music players, cellular phones, tablet computers, personal digital assistants (PDAs), digital cameras, camcorders, and portable DVD players, etc. 2.5 mm plugs are not as common, but are used on communication equipment such as cordless phones, cellular telephones, and two-way radios.

Audio jacks and audio sockets typically have two, three, four, or sometimes five contacts. Three-contact audio jacks/sockets are referred to as TRS audio jacks/sockets, where T stands for “tip,” R stands for “ring,” and S stands for “sleeve.” Similarly, two-, four-, and five-contact audio jacks/sockets are referred to as TS, TRRS, and TRRRS audio jacks/sockets, respectively.

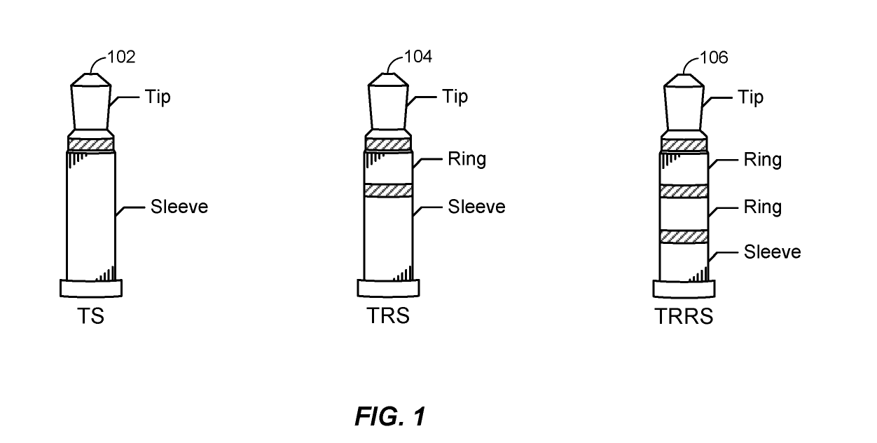

FIG. 1 illustrates the tip (T), ring (R), and sleeve (S) configuration of various types of audio jacks. Specifically, FIG. 1 illustrates a TS audio jack 102, a TRS audio jack 104, and a TRRS audio jack 106. As can be seen in FIG. 1, each tip (T), ring (R), and sleeve (S) is a conductive contact of the respective audio jack separated from the other conductive contacts of the audio jack by a black insulating band (although the insulating band need not be black). The conductive contacts are typically made of a conductive metal such as copper, aluminum, gold, silver, etc. The insulating bands are typically made of a non-conductive material, such as plastic.

Each contact of an audio jack/socket may be used for a different input/output signal. Three- or four-contact (TRS or TRRS) audio sockets are common on cellular telephones, providing mono (three-contact) or stereo (four-contact) sound, microphone audio, and signaling (e.g., push a button to answer a call). For example, for a TRS audio jack/socket, the tip (T) may be used for mono audio, the ring (R) may be used for microphone audio, and the sleeve (S) may be used for the ground, and can also be used for signaling input. As another example, for a TRRS audio jack/socket, the tip (T) may be used for the left audio, the first ring (R) may be used for the right audio, the second ring (R) may be used for the microphone audio, and the sleeve (S) may be used for the ground. Note that the uses of the four contacts of a TRRS audio jack/socket have not been standardized, and as such, different manufacturers may use the four TRRS contacts for different purposes than other manufacturers.

Generally, the type of audio jack should match the type of audio socket. Thus, if, for example, an audio jack is plugged into a TRRS audio socket having a particular configuration of contacts (e.g., tip (T) used for left audio, the first ring (R) used for right audio, etc.), the audio jack should be a TRRS audio jack having that same configuration. However, while any type of 3.5 mm (for example) audio jack can be plugged mechanically into any type of 3.5 mm audio socket, many combinations are electrically incompatible. A mismatch between the type of audio jack and the type of audio socket, such as plugging a TRRS audio jack into a TRS audio socket (or the reverse) or plugging a TRRS audio jack from one manufacturer into a TRRS audio socket from another manufacturer, can cause the electronic device to not function correctly, or at all. As a specific example, plugging a TRRS audio jack into a TRS audio socket may cause the microphone of the electronic device to be muted.

While certain mismatches may not have any deleterious effects on the electronic device other than the effect on the user experience (e.g., muting the microphone), other combinations may actually damage the audio hardware of the electronic device. For example, the power circuitry of either of the audio jack or the audio socket could be harmed by a mismatch. In addition, the electronic device does not alert the user to such a mismatch, which would enable the user to correct it.

Accordingly, aspects of the disclosure relate to notifying a user of a mismatch between an audio jack and an audio socket of an electronic device. In an aspect, after an audio jack is plugged into the audio socket of the electronic device, the electronic device determines whether or not the type of the audio jack (e.g., TS, TRS, TRRS, etc.) matches the type of the audio socket. If there is a mismatch between the type of the audio jack and the type of the audio socket, the electronic device can alert the user of the mismatch. The electronic device can also notify the user of whether the mismatch is harmful to the audio hardware of the electronic device, whether the microphone will be muted because of the mismatch, about the effect of the mismatch on the audio mixing pattern of the electronic device, or whether or not the stereo effect of the audio will be lost due to the mismatch. As noted above, the mismatch can cause the microphone to be muted when the mismatch is between a TRS audio jack and a TRRS audio socket, or vice versa.

In addition to notifying the user of the mismatch, the electronic device can take corrective action to mitigate the effects of the mismatch. For example, if the mismatch will damage the audio hardware of the electronic device, the electronic device can shut down the effected audio components upon detection and notify the user of the action taken. For example, the power circuitry of either of the audio jack or the audio socket could be harmed by a mismatch. In that case, the power circuitry of the audio socket can be shut down to prevent the audio socket from interacting with the audio jack. In cases where the mismatch is not harmful to the audio hardware but the mismatch will cause certain audio effects to be lost, such as the stereo effect, the electronic device can run an internal calibration optimization to nullify, or at least mitigate, the effects of the mismatch.

For example, as noted above, when a TRS audio jack is plugged into a TRRS audio socket, it may cause the microphone of the electronic device to be muted. In addition to the microphone being muted, when music is being transferred from the audio socket to the audio jack (e.g., where the audio jack corresponds to headphones plugged into the audio socket of the electronic device), any voice audio may be distorted because the background music and voice audio are sent through different channels to provide a near-far effect. To address this issue, the electronic device can change the audio mixing pattern to nullify, or at least mitigate, the effects of the mismatch.

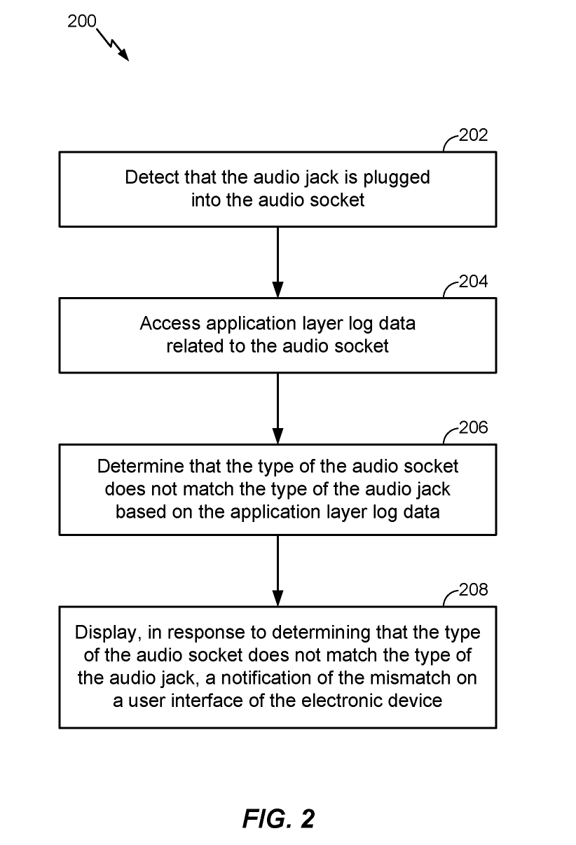

FIG. 2 illustrates an exemplary method 200 for detecting a mismatch between a type of an audio socket of an electronic device and a type of an audio jack. In an aspect, the type of the audio socket may be one of TS, TRS, TRRS, or TRRRS, and the type of the audio jack may be a different one of TS, TRS, TRRS, or TRRRS or the same one of TS, TRS, TRRS, or TRRRS but from a different manufacturer than the audio socket and having a configuration that is incompatible with the audio socket. The audio jack and the audio socket may be 2.5 mm, 3.5 mm, or 6.35 mm.

At 202, the electronic device detects that an audio jack has been plugged into the audio socket.

At 204, the electronic device accesses application layer log data related to the audio socket. The application layer log data may be, for example, Android® Debug Bridge (ADB) log data where the operating system of the electronic device is an Android® or Android®-based operating system, Console log or Phone log data where the operating system of the electronic device is an Apple® operating system, or Debug.log data where the operating system of the electronic device is a Windows® operating system.

At 206, the electronic device determines that the type of the audio socket does not match the type of the audio jack based on the application layer log data. For example, when a TRS audio jack is plugged into a TRS audio socket, the following log data may be generated:

/dev/input/event3: EV_SW SW_HEADPHONE_INSERT 00000001

/dev/input/event3: EV_SW SW_JACK_PHYSICAL_INS 00000001

/dev/input/event3: EV_SYN SYN_REPORT 00000000

However, when a TRRS audio jack is plugged into a TRS audio socket, the following log data may be generated:

/dev/input/event3: EV_SW SW_HEADPHONE_INSERT 00000001

/dev/input/event3: EV_SW SW_MICROPHONE_INSERT 00000001

/dev/input/event3: EV_SW SW_JACK_PHYSICAL_INS 00000001

/dev/input/event3: EV_SYN SYN_REPORT 00000000

Based on the entry “SW_MICROPHONE_INSERT 00000001” and the knowledge that the audio socket is a TRS audio socket, the electronic device can determine that there is a mismatch between the audio jack and the audio socket.

At 208, the electronic device displays, in response to determining that the type of the audio socket does not match the type of the audio jack, a notification of the mismatch on a user interface of the electronic device. The notification may inform the user of the type of the audio socket and the type of the audio jacket and/or the effects of the mismatch. In an aspect, if the mismatch will damage the hardware audio components of the electronic device, the notification may inform the user of the potential damage and instruct the user to remove the audio jack from the audio socket. In another aspect, the notification may indicate whether or not the effects of the mismatch can be corrected and may provide the user with options to correct the effects of the mismatch.

For example, if the mismatch can be corrected by changing the audio mixing pattern (e.g., where a TRS audio jack is plugged into a TRRS audio socket), the electronic device can determine multiple audio mixing patterns that would correct the mismatch and display the audio mixing patterns on the user interface of the electronic device. The user can then select one of the audio mixing patterns via the user interface. In an aspect, the electronic device can highlight an audio mixing pattern of the multiple audio mixing patterns that is most likely to correct the mismatch.

In another aspect, where the mismatch mutes the microphone of the electronic device, the notification can inform the user that the microphone is muted and instruct the user to unmute the microphone.

In an aspect, the electronic device may perform operations to nullify, or at least mitigate, the effects of the mismatch automatically, without user intervention, and simply notify the user that the electronic device has taken the action. For example, if the electronic device determines that the mismatch will harm one or more audio components of the electronic device, the electronic device can automatically disable the one or more audio components of the electronic device and then inform the user that it has done so. As a specific example, the mismatch may harm one or more hardware audio components based on a ground contact of the audio socket touching a microphone contact of the audio jack, or vice versa. This can occur where the audio jack and the audio socket are a TRRS audio jack and audio socket but have a different contact configuration from each other.

As another example, where the mismatch can be corrected by adjusting the audio mixing pattern and there is only one audio mixing pattern that will correct the mismatch, or an audio mixing pattern most likely to correct the mismatch, the electronic device may automatically change the current audio mixing pattern to the new audio mixing pattern.

In an aspect, there may not be an audio mixing pattern that would correct the mismatch. In that case, the electronic device can mute the microphone and display a notification on the user interface that adjusting the audio mixing pattern will not correct the mismatch. In other cases, the electronic device can unmute the microphone and display a notification on the user interface that adjusting the audio mixing pattern will not correct the mismatch. As will be appreciated, the microphone can muted or unmuted based on the type of the mismatch (e.g., whether the mismatch caused the microphone to be muted).

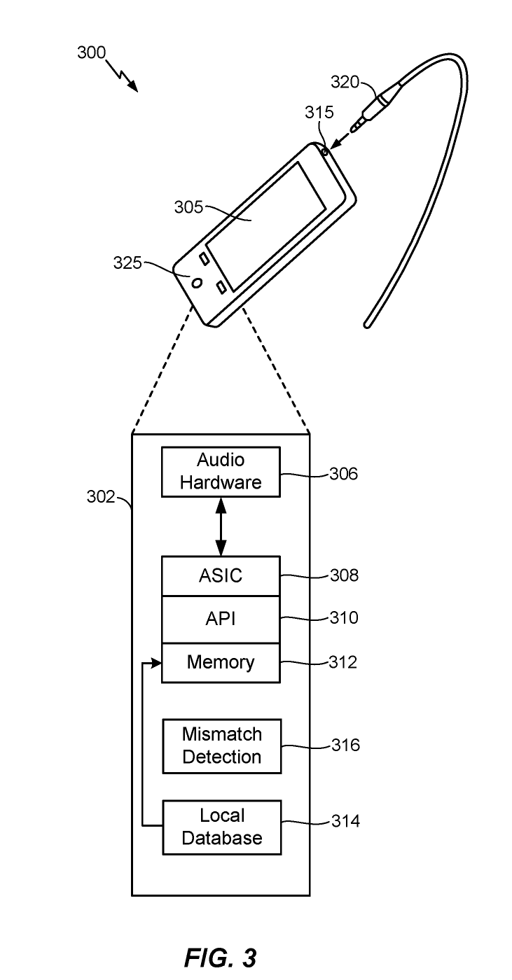

FIG. 3 illustrates an example of an electronic device 300 in accordance with aspects of the disclosure. In the example of FIG. 3, the electronic device 300 is illustrated as a touchscreen device, such as a “smartphone.” However, as will be appreciated, the techniques described herein are not limited to cellular telephones, but rather to any electronic device having an audio socket and some kind of user interface. As shown in FIG. 3, an external casing of the electronic device 300 is configured with a touchscreen display 305, an audio socket 315 capable of receiving an audio jack 320, at least one front-panel button 325 (e.g., a “Home” button, etc.), among other components, as is known in the art.

While internal components of the electronic device 300 can be embodied with different hardware configurations, a basic high-level configuration for internal hardware components is shown as platform 302 in FIG. 3. The platform 302 can include audio hardware 306, such as a microphone, speakers, the power circuitry for the audio socket 315, etc. operably coupled to an application specific integrated circuit (ASIC) 308, or other processor, microprocessor, logic circuit, or other data processing device. The ASIC 308 or other processor executes the application programming interface (API) 310 layer that interfaces with any resident programs in a memory 312 of the electronic device. The memory 312 can be comprised of read-only memory (ROM) or random-access memory (RAM), electrically erasable programmable ROM (EEPROM), flash cards, or any memory common to computer platforms. The platform 302 also can include a local database 314 that can store applications not actively used in the memory 312, as well as other data. The local database 314 is typically a flash memory cell, but can be any secondary storage device as known in the art, such as magnetic media, EEPROM, optical media, tape, soft or hard disk, or the like.

The platform 302 further includes a mismatch detection module 316. The mismatch detection module 316 may be a hardware circuit coupled to or incorporated into the ASIC 308, a software module stored in the memory 312 and/or the local database 314 executed by the ASIC 308, or a combination of hardware and software. The mismatch detection module 316 may, when executed, cause the electronic device 300 to perform the operations described herein with reference to FIG. 2.

For example, where the electronic device 300 is configured to detect a mismatch between the type of the audio socket 315 and the type of the audio jack 320, the memory 312 and/or the local database 314 may be configured to store application layer log data related to the audio socket 315, and the ASIC 308 in conjunction with the mismatch detection module 316 may be configured to detect that the audio jack 320 is plugged into the audio socket 315, access the application layer log data related to the audio socket from the memory 312 or the local database 316, and determine that the type of the audio socket 315 does not match the type of the audio jack 320 based on the application layer log data. The ASIC 308 may be further configured to cause the touchscreen display 305 to display, in response to the determination that the type of the audio socket 315 does not match the type of the audio jack 320, a notification of the mismatch.

Accordingly, an aspect of the disclosure can include an electronic device (e.g., electronic device 300) including the ability to perform the functions described herein. As will be appreciated by those skilled in the art, the various logic elements can be embodied in discrete elements, software modules executed on a processor or any combination of software and hardware to achieve the functionality disclosed herein. For example, the ASIC 308, the API 310, the memory 312, the local database 314, and the mismatch detection module 316 may all be used cooperatively to load, store and execute the various functions disclosed herein and thus the logic to perform these functions may be distributed over various elements. Alternatively, the functionality could be incorporated into one discrete component. Therefore, the features of the electronic device 300 in FIG. 3 are to be considered merely illustrative and the disclosure is not limited to the illustrated features or arrangement.

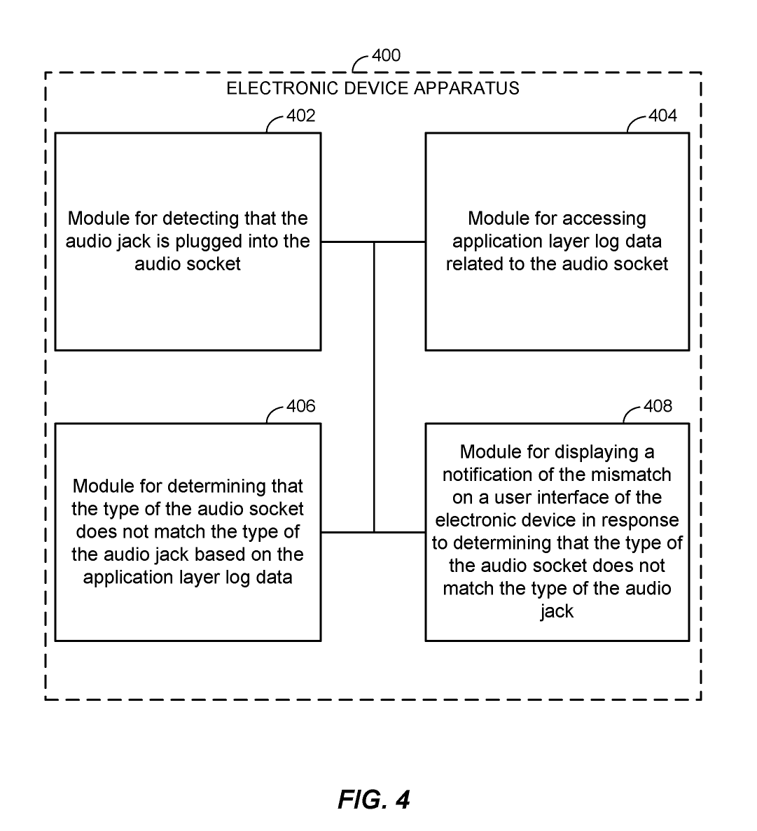

FIG. 4 illustrates an example electronic device apparatus 400 represented as a series of interrelated functional modules. A module for detecting 402 may correspond at least in some aspects to, for example, the power circuitry of the audio socket and/or the ASIC 308 in conjunction with the mismatch detection module 316, as discussed herein. A module for accessing 404 may correspond at least in some aspects to, for example, a processing system, such as ASIC 308 in conjunction with mismatch detection module 316 and memory 312 or local database 314 (whichever stores the application layer log data), as discussed herein. A module for determining 406 may correspond at least in some aspects to, for example, a processing system, such as ASIC 308 in conjunction with mismatch detection module 316, as discussed herein. A module for displaying 408 may correspond at least in some aspects to, for example, a processing system in conjunction with a user interface, such as ASIC 308 in conjunction with mismatch detection module 316 and touchscreen display 305, as discussed herein.

The functionality of the modules of FIG. 4 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 4, as well as other components and functions described herein, may be implemented using any suitable means. Such means also may be implemented, at least in part, using corresponding structure as taught herein. For example, the components described above in conjunction with the “module for” components of FIG. 4 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an electronic device. In the alternative, the processor and the storage medium may reside as discrete components in an electronic device.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of detecting a mismatch between a type of an audio socket of an electronic device and a type of an audio jack, comprising:
detecting, by the electronic device, that the audio jack is plugged into the audio socket;
accessing, by the electronic device, application layer log data related to the audio socket;
determining, by the electronic device, that the type of the audio socket does not match the type of the audio jack based on the application layer log data; and
in response to determining that the type of the audio socket does not match the type of the audio jack, displaying, by the electronic device, a notification of the mismatch on a user interface of the electronic device.

2. The method of claim 1, further comprising:
in response to determining that the type of the audio socket does not match the type of the audio jack, determining whether the mismatch will harm one or more audio components of the electronic device; and
in response to determining that the mismatch will harm at least one of the one or more audio components of the electronic device, disabling the at least one of the one or more audio components of the electronic device.

3. The method of claim 2, wherein the mismatch will harm the at least one of the one or more audio components based on a ground contact of the audio socket touching a microphone contact of the audio jack, or on a microphone contact of the audio socket touching a ground contact of the audio jack.

4. The method of claim 1, further comprising:
in response to determining that the type of the audio socket does not match the type of the audio jack, determining whether the mismatch can be corrected; and
in response to determining that the mismatch can be corrected, correcting the mismatch.

5. The method of claim 4, wherein the type of the audio jack is a TRS type of audio jack and the type of the audio socket is a TRRS type of audio socket, or the type of the audio jack is a TRRS type of audio jack and the type of the audio socket is a TRS type of audio socket.

6. The method of claim 5, wherein correcting the mismatch comprises determining whether or not there is at least one audio mixing pattern of the electronic device that would correct the mismatch.

7. The method of claim 6, further comprising:
based on determining that there is not an audio mixing pattern that would correct the mismatch, muting a microphone of the electronic device and displaying a notification on the user interface that adjusting the audio mixing pattern of the electronic device will not correct the mismatch.

8. The method of claim 6, further comprising:
based on determining that there is not an audio mixing pattern that would correct the mismatch, unmuting a microphone of the electronic device and displaying a notification on the user interface that adjusting the audio mixing pattern of the electronic device will not correct the mismatch.

9. The method of claim 6, further comprising:
based on there being a plurality of audio mixing patterns that would correct the mismatch, displaying the plurality of audio mixing patterns on the user interface of the electronic device; and
receiving a selection of one of the plurality of audio mixing patterns via the user interface.

10. The method of claim 9, wherein displaying the plurality of audio mixing patterns further comprises highlighting an audio mixing pattern of the plurality of audio mixing patterns most likely to correct the mismatch.

11. The method of claim 9, wherein a microphone of the electronic device is muted or unmuted based on a type of the mismatch and the selected one of the plurality of audio mixing patterns.

12. The method of claim 1, wherein the type of the audio socket is one of TS, TRS, TRRS, or TRRRS.

13. The method of claim 12, wherein the type of the audio jack is a different one of TS, TRS, TRRS, or TRRRS.

14. The method of claim 1, wherein the audio socket is a 3.5 mm audio socket, and wherein the audio jack is a 3.5 mm audio jack.

15. The method of claim 1, wherein the application layer log data comprises Android® Debug Bridge (ADB) log data, Apple® Console log or Phone log data, or Windows® Debug.log data.

16. An apparatus for detecting a mismatch between a type of an audio socket of an electronic device and a type of an audio jack, comprising:
the audio socket;
a memory configured to store application layer log data related to the audio socket; and
at least one processor configured to:
detect that the audio jack is plugged into the audio socket;
access the application layer log data related to the audio socket from the memory; and
determine that the type of the audio socket does not match the type of the audio jack based on the application layer log data; and
a user interface configured to display, in response to the determination that the type of the audio socket does not match the type of the audio jack, a notification of the mismatch.

17. The apparatus of claim 16, wherein the at least one processor is further configured to:
determine, in response to the determination that the type of the audio socket does not match the type of the audio jack, whether the mismatch will harm one or more audio components of the electronic device; and
disable, in response to the determination that the mismatch will harm at least one of the one or more audio components of the electronic device, the at least one of the one or more audio components of the electronic device.

18. The apparatus of claim 17, wherein the mismatch will harm the at least one of the one or more audio components based on a ground contact of the audio socket touching a microphone contact of the audio jack, or on a microphone contact of the audio socket touching a ground contact of the audio jack.

19. The apparatus of claim 16, wherein the at least one processor is further configured to:
determine, in response to the determination that the type of the audio socket does not match the type of the audio jack, whether the mismatch can be corrected; and
correct, in response to the determination that the mismatch can be corrected, the mismatch.

20. The apparatus of claim 19, wherein the type of the audio jack is a TRS type of audio jack and the type of the audio socket is a TRRS type of audio socket, or the type of the audio jack is a TRRS type of audio jack and the type of the audio socket is a TRS type of audio socket.

21. The apparatus of claim 20, wherein the at least one processor being configured to correct the mismatch comprises the at least one processor being configured to determine whether or not there is at least one audio mixing pattern of the electronic device that would correct the mismatch.

22. The apparatus of claim 21, wherein the at least one processor is further configured to:
mute, based on the determination that there is not an audio mixing pattern that would correct the mismatch, a microphone of the electronic device and cause the user interface to display a notification on the user interface that adjusting the audio mixing pattern of the electronic device will not correct the mismatch.

23. The apparatus of claim 21, wherein the at least one processor is further configured to:
unmute, based on the determination that there is not an audio mixing pattern that would correct the mismatch, a microphone of the electronic device and cause the user interface to display a notification on the user interface that adjusting the audio mixing pattern of the electronic device will not correct the mismatch.

24. The apparatus of claim 21, wherein the user interface is further configured to:
display, based on there being a plurality of audio mixing patterns that would correct the mismatch, displaying the plurality of audio mixing patterns on the user interface of the electronic device; and
receive a selection of one of the plurality of audio mixing patterns via the user interface.

25. The apparatus of claim 24, wherein the user interface being configured to display the plurality of audio mixing patterns further comprises the user interface being configured to highlight an audio mixing pattern of the plurality of audio mixing patterns most likely to correct the mismatch.

26. The apparatus of claim 24, wherein a microphone of the electronic device is muted or unmuted based on a type of the mismatch and the selected one of the plurality of audio mixing patterns.

27. The apparatus of claim 16, wherein the type of the audio socket is one of TS, TRS, TRRS, or TRRRS, and wherein the type of the audio jack is a different one of TS, TRS, TRRS, or TRRRS.

28. The apparatus of claim 16, wherein the audio socket is a 3.5 mm audio socket, and wherein the audio jack is a 3.5 mm audio jack.

29. An apparatus for detecting a mismatch between a type of an audio socket of an electronic device and a type of an audio jack, comprising:
the audio socket;
a storage means configured to store application layer log data related to the audio socket; and
a processing means configured to:
detect that the audio jack is plugged into the audio socket;
access the application layer log data related to the audio socket from the storage means; and
determine that the type of the audio socket does not match the type of the audio jack based on the application layer log data; and
an interface means configured to display, in response to the determination that the type of the audio socket does not match the type of the audio jack, a notification of the mismatch.

30. A non-transitory computer-readable medium storing computer-executable instructions for detecting a mismatch between a type of an audio socket of an electronic device and a type of an audio jack, the computer-executable instructions comprising:
at least one instruction to cause the electronic device to detect that the audio jack is plugged into the audio socket;
at least one instruction to cause the electronic device to access application layer log data related to the audio socket;
at least one instruction to cause the electronic device to determine that the type of the audio socket does not match the type of the audio jack based on the application layer log data; and
at least one instruction to cause the electronic device to display, in response to determining that the type of the audio socket does not match the type of the audio jack, a notification of the mismatch on a user interface of the electronic device.
